(19) United States
(12) Patent Application Publication
(10) Pub. No.: US 2004/0025410 A1
(43) Pub. Date: Feb. 12, 2004

(54) Rodent traps

(76) Inventor: Paul Shapland, Coulsdon (GB)

Correspondence Address: EDWARDS & ANGELL, LLP, P.O. BOX 9169, BOSTON, MA, 02209, US

(21) Appl. No.: 10/344,541

(22) PCT Filed: Aug. 6, 2001
(86) PCT No.: PCT/GB01/03549

(30) Foreign Application Priority Data
Aug. 12, 2000 (GB) 0019824.2

(51) Int. Cl. A01M 23/08

(52) U.S. Cl. 43/65

(57) ABSTRACT

The invention relates to a rodent trap comprising one or more rodent entry means (1)secured to catch compartment (2) for containing rodents once they have been caught. Each entry means (1) allows a rodent to enter the catch compartment (2) but prevents the rodent from exiting the catch compartment (2). Each entry means (1) is releasably secured to the catch compartment (2). Each entry means (1) comprises an enclosed corridor having a fist aperture (9) for the rodent to exit the entry means (1) into the catch compartment (2). An internal sealing means (3) is associated with the entry means (1). An external sealing means (12) is provided to seal the catch compartment (2) after use.

The present invention relates to improvements to traps for rodents. However, the traps could be used for other small animals.

In the context of the present invention the term “rodent” will be used to include mice, rats and other small animals.

Many types of traps are available for catching rodents. The most common type of rodent trap has a spring-loaded bar which can be held in tension by means of a lever that is activated by the rodent stepping onto the trap to eat bait. This type of trap is generally messy and unhygienic and must be emptied, cleaned and reset after each catch. It is also well known to lure rodents into boxes containing poison, to kill the rodent instantly or over a period of time. In this case there is no trap to be reset but the catch must be found and disposed of.

There are traps available which catch a single rodent by luring the rodent into a container having a door and bait secured to a door release mechanism, so that when the rodent collects the bait the release mechanism causes the door to close the container entrance. This type of trap is not particularly suitable where there are a large number of rodents to be caught, furthermore the trap must be cleaned out if it is to be used again and biological materials can escape from the trap.

Multiple rodent traps are available having entry means that allow a rodent to enter the trap, prevent its escape and then reset to allow further rodents to enter. The entrance means may, for example, be a spring loaded trap door or one or more vanes mounted on a rotatable shaft. A disadvantage of this type of multiple rodent trap is that the trap must be emptied and cleaned before it can be reused, which is a messy, unhygienic and unpleasant task.

The aim of the present invention is therefore to provide a trap for catching one or more rodents that contains the rodent and any related biological materials, preferably conceals the catch from view and also avoids the need to empty and clean the rodent containing compartment. It is also an aim of the invention to reduce the time spent servicing the traps and to improve the hygiene conditions of the job of servicing the traps.

Accordingly, the present invention provides a rodent trap comprising one or more rodent entry means secured to a catch compartment for containing rodents once they have been caught, wherein the or each entry means allows a rodent to enter the catch compartment but prevents the rodent from exiting the catch compartment and the or each entry means is releasably secured to the catch compartment.

The advantage of the or each entry means being releasably secured to the catch compartment is that the or each entry means can be detached from the used catch compartment and secured to a new catch compartment for further use.

The or each entry means preferably comprises an enclosed corridor having a first aperture for a rodent to enter the entry means and a second aperture for the rodent to exit the entry means into the catch compartment. The or each entry means is preferably rectangular in section. The first and second apertures may be positioned in opposite ends of the entry means. Alternatively the first aperture may be positioned in one end of the entry means and the second aperture may be positioned in a side wall of the entry means.

Means are preferably provided to prevent the rodent from leaving the or each entry means once it has passed through the first aperture and has begun travelling towards the second aperture.

The means to prevent the rodent from leaving the entry means is preferably a seesaw arrangement comprising a seesaw having a first position and a second position. In the first position a first end of the seesaw rests on the base of the entry means allowing a rodent to enter through the first aperture, while a second end of the seesaw is elevated and closes the second aperture. The seesaw preferably moves under the weight of the rodent to the second position, in which the second end of the seesaw rests on the base of the entry means and the first end of the seesaw is then elevated. Therefore the rodent can exit the entry means through the second aperture into the catch compartment but the first aperture is blocked preventing escape of the rodent from the entry means.

The see-saw is preferably weighted, so that once the rodent has stepped off the second end into the catch compartment the seesaw returns to the first position, blocking the exit from the catch compartment through the second aperture and allowing further rodents to enter the trap through the first aperture.

The seesaw can be made from a plastics material such as polypropylene or polyethylene, a metal, such as steel or a zinc based alloy, a wood or a combination of materials.

The means to prevent the rodent from leaving the or each entry means may alternatively comprise a curtain. The curtain is preferably positioned behind the first aperture such that it can be easily pushed out of the way by a rodent entering the entry means through the first aperture. The curtain cannot be pushed out of the way by a rodent trying to leave the entry means through the first aperture. A stop may be provided in the entry means between the curtain and the outside of the entry means to prevent the curtain from being pushed through the first aperture by a rodent trying to leave the trap.

The curtain may be made from any suitable material such as a metal, particularly a lightweight metal, for example aluminium, or rubber. The curtain is preferably as wide as the entry means.

The curtain is most preferably a curved metal flap. The flap is preferably secured to the upper, inner surface of the entry means such that it depends therefrom and curves away from the first aperture extending along the base of the entry means towards the second aperture. In use the rodent easily pushes the curved metal flap upwards out of the way as it enters the entry means through the first aperture. The rodent is, however, unable to return under the flap owing to the shape of the flap.

The curtain may alternatively be made from a heavy rubber. The curtain may be secured by its upper edge to the upper, inner surface of the entry means such that all or most of the weight of the curtain hangs from its upper edge making it harder for a rodent to move the curtain from inside the entry means. The curtain may additionally be weighted along its lower edge. The curtain may also extend along the base of the entry means towards the second aperture again making it harder for the rodent to exit the entry means.

The or each entry means may be provided with one or more means to indicate the presence of rodents in the trap.

The means to indicate the presence of rodents in the trap may be a flag mechanism. Preferably a flag is moved from a first position to a second position on entry of a rodent into the catch compartment through the entry means. The use of a flag mechanism means that the person servicing the trap can see, by means of the position of the flag, whether the trap contains any rodents without wasting time examining the trap carefully.

The means to indicate the presence of rodents in the trap may be a counter mechanism. Preferably the counter is moved each time a rodent enters the catch compartment through the entry means. The use of a counter mechanism means that the person servicing the trap can see quickly and easily how many rodents are in the trap.

The entry means may be made totally or partially from a metal, preferably by die-casting. The metal may be, for example, aluminium, zinc or an alloy of aluminium and zinc. Alternatively the entry means can be made from a plastics material such as polypropylene, polyethylene or other similar thermoplastic materials.

The entry means preferably comprises two or more inter-connectable portions. The entry means may be divided along a vertical longitudinal axis or along a horizontal longitudinal axis into two or more inter-connectable portions. Alternatively the entry means may be divided along one or more vertical axes positioned at 90° to either longitudinal axis into two or more inter-connectable portions. The inter-connectable portions are preferably connected by means of male and female connecting parts. A clip, preferably a “C” shaped clip, may also be provided to secure the inter-connectable portions together.

The entry means is preferably made of two or more inter-connecting portions to allow it to be easily and quickly taken apart for cleaning.

The or each entry means may be secured to the catch compartment by complementary screw threads provided on the catch compartment and the entry means. Alternatively the catch compartment and the or each entry means may be secured together by means of push-fit engagement or by male-female engaging clips. Any clips used to secure the catch compartment to the entry means are preferably tamperproof.

The or each entry means is preferably associated in use with an internal sealing member. The internal sealing member preferably engages the inside edges of the aperture in the catch compartment that receives the entry means on removal of the entry means to at least partially seal the aperture once the entry means is removed. The use of the internal sealing means prevents the escape of any live catch or prevents or reduces the escape of any associated biological materials when the or each entry means is removed from the catch compartment.

The catch compartment is preferably disposable. The catch compartment is preferably made from a plastics material, most preferably by blow or injection moulding. Suitable plastics materials include polyethylene, polypropylene and other similar thermoplastic materials. A plastics material is advantageous as it is cheap but strong, thereby allowing the catch compartment to be disposable but to withstand bites and scratches from the rodents.

The catch compartment may alternatively be extruded or rolled from tin plated steel or aluminium. The use of a disposable catch compartment means that the compartment does not need to be emptied and cleaned: it can simply be discarded along with its contents and a new catch compartment can be used. This decreases the servicing time and increases the hygiene involved with re-setting the trap.

The catch compartment may be any shape, for example, semi-circular, square or rectangular. The catch compartment preferably comprises two separate parts or alternatively two parts connected by one or more hinges or by a common side, which in use co-operate to form a catch compartment. The two parts are preferably secured together in use to form the catch compartment by the use of male and female engaging clip portions (in addition to hinges or a common side where these are provided).

The catch compartment is designed to reduce or, more preferably, prevent the escape of biohazards such as blood or urine from the catch compartment. The two parts of the catch compartment are preferably shaped such that their connection occurs in a generally horizontal plane above the surface on which the catch compartment is positioned. This limits the opportunity for biohazards to escape through the connection between the two parts. The connection between the two parts of the catch compartment is preferably a liquid tight seal.

The catch compartment is provided in “flat-pack” form so that a number of parts of catch compartments can be stacked and carried around more easily and in greater numbers than if the catch compartments were carried around in the assembled form, again decreasing servicing time.

The catch compartment may include a transparent portion to allow the catch to be inspected. The catch compartment may also include poison to kill the rodents or small holes to allow the rodents to be drowned. Bait may be provided in the catch compartment.

The trap may be provided with a case to protect it from being tampered with. The trap may be secured to the case, for example by push-fit engagement or clip engagement. The clips are preferably tamperproof. The case may be secured to a surface such as a wall or a floor to prevent the trap from being damaged by, for example vehicles in warehouses.

The trap may be provided with an external sealing means for sealing the catch compartment when it has been detached from the entry means. The external sealing means prevents the escape of any of the contents of the catch compartment adding to the ability to safely handle the catch compartment after removal of the entry means and before and during disposal of the used catch compartment. The external sealing means may be housed in a complementary recess in the catch compartment when it is not in use.

The present invention will now be illustrated, merely by way of example, with reference to the accompanying drawings in which:

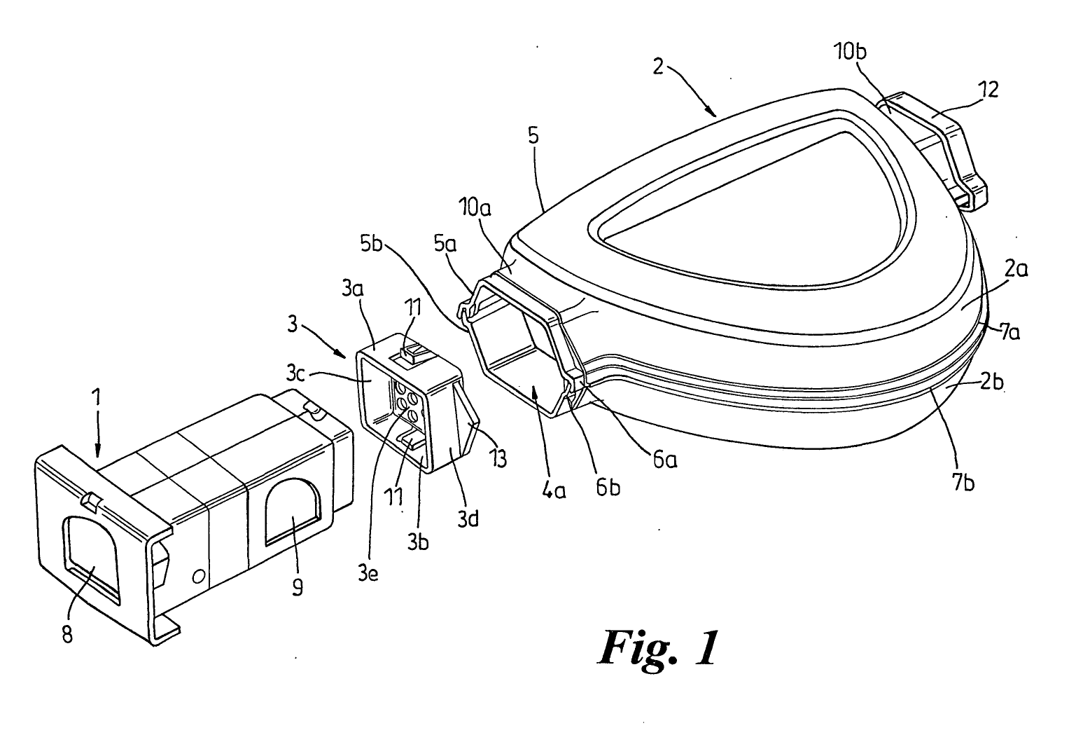

FIG. 1 shows an expanded perspective view of a first embodiment of the trap of the present invention;

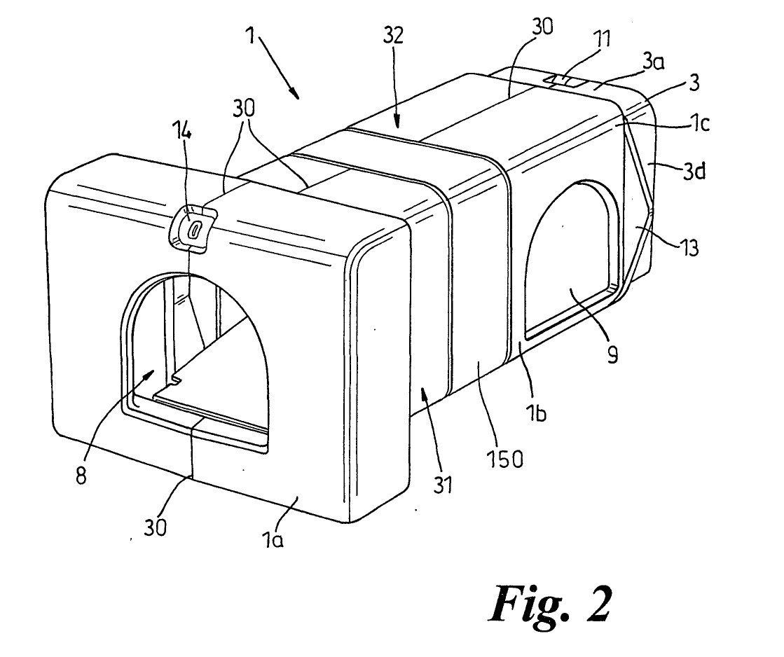

FIG. 2 shows a perspective view of the entry means of FIG. 1;

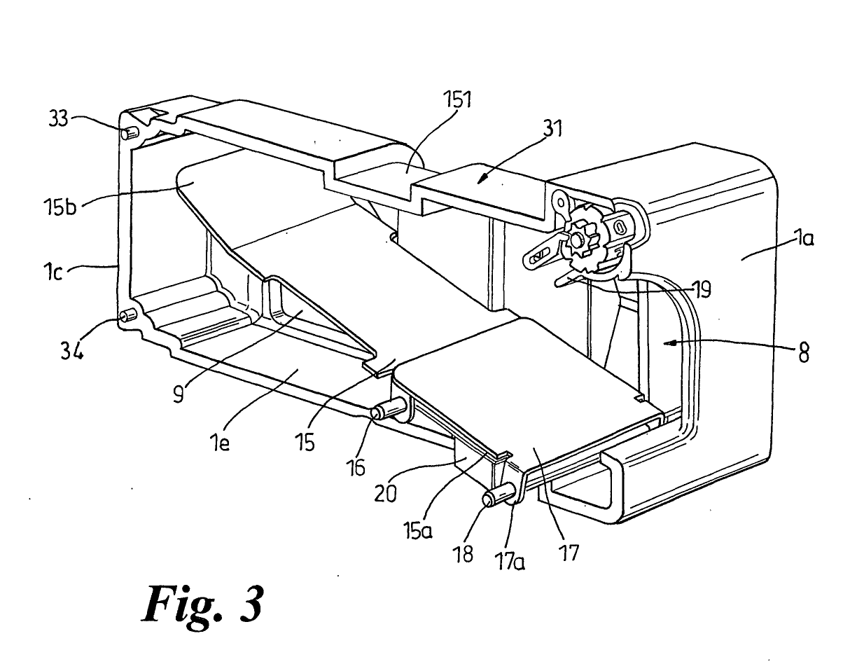

FIG. 3 shows, a perspective side view of the entry means of FIG. 2 with the seesaw in the first position and the portion 32 removed;

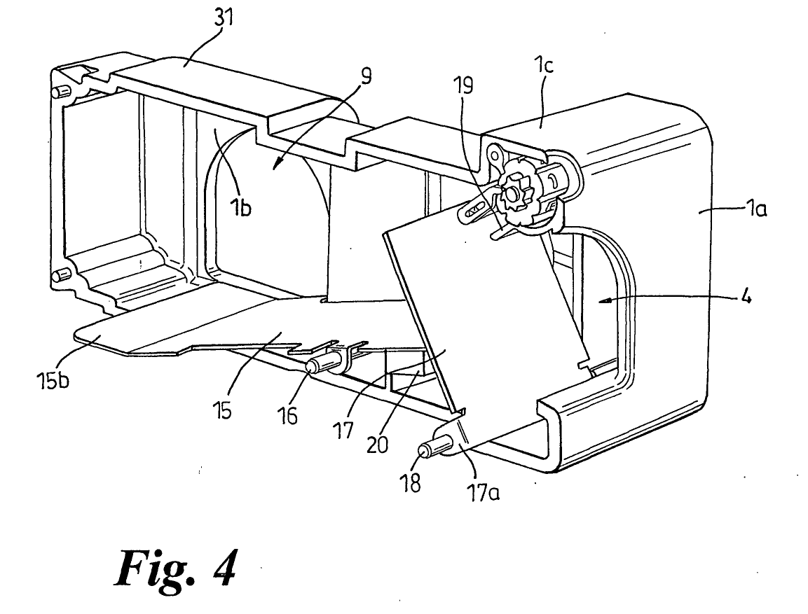

FIG. 4 shows a perspective side view of the entry means of FIG. 2, with the seesaw in the second position and the portion 32 removed;

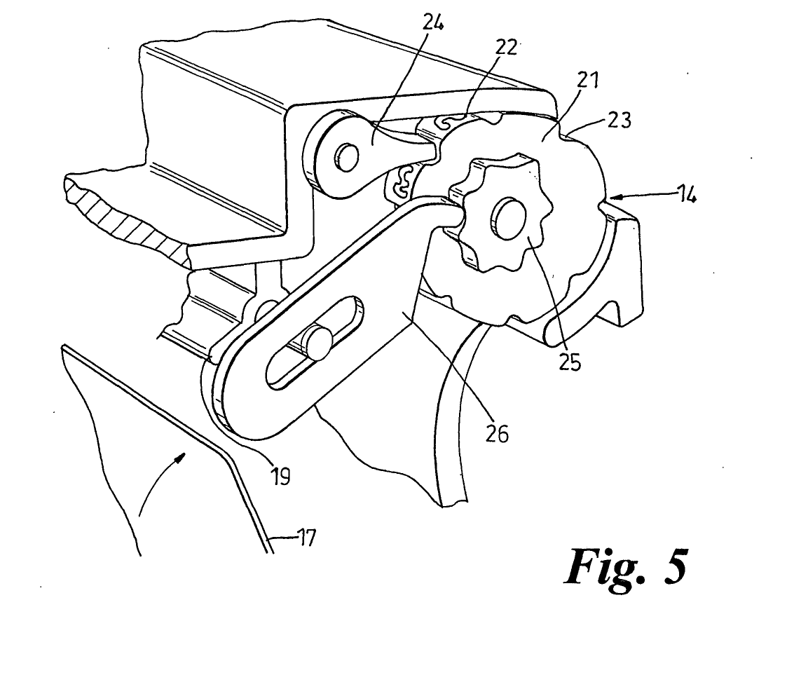

FIG. 5 shows a perspective side view of the counter mechanism of the entry means of FIGS. 3 and 4;

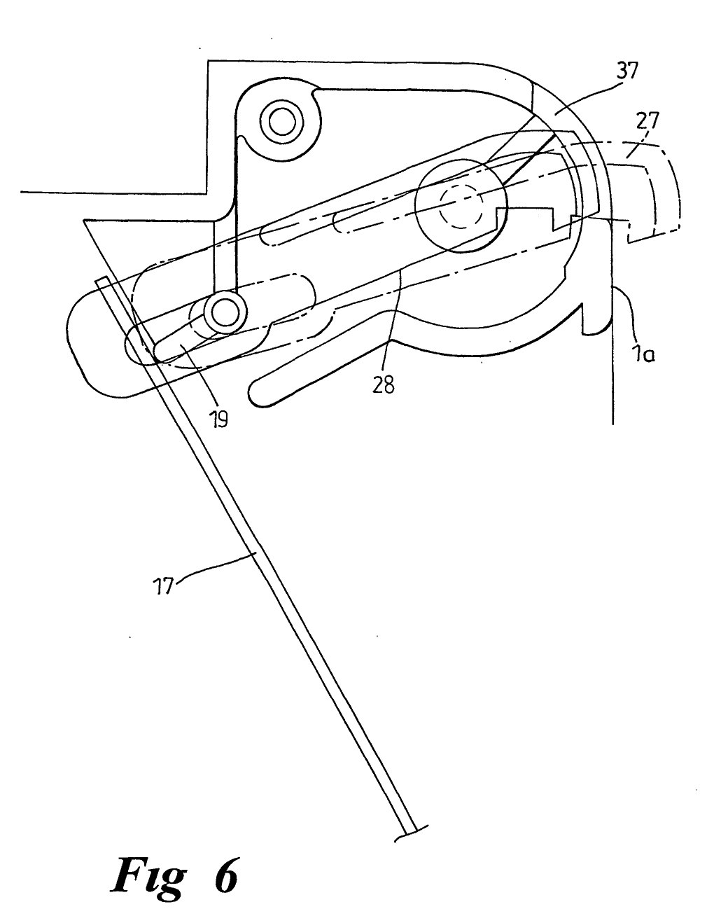

FIG. 6 shows a side view of a flag mechanism for use with the entry means of FIG. 2;

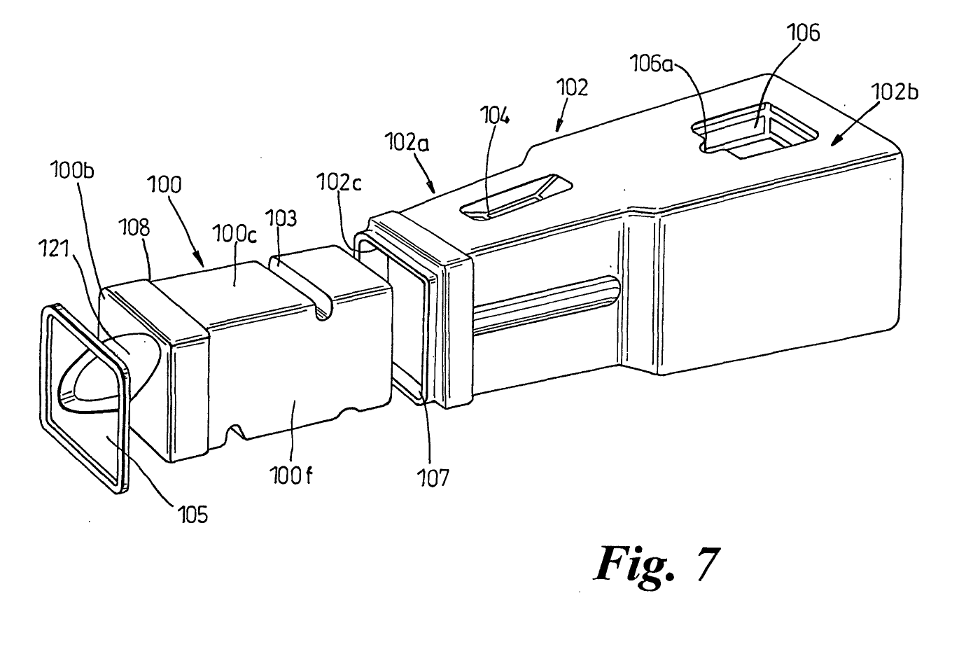

FIG. 7 shows an expanded perspective view of a trap of a second embodiment the present invention;

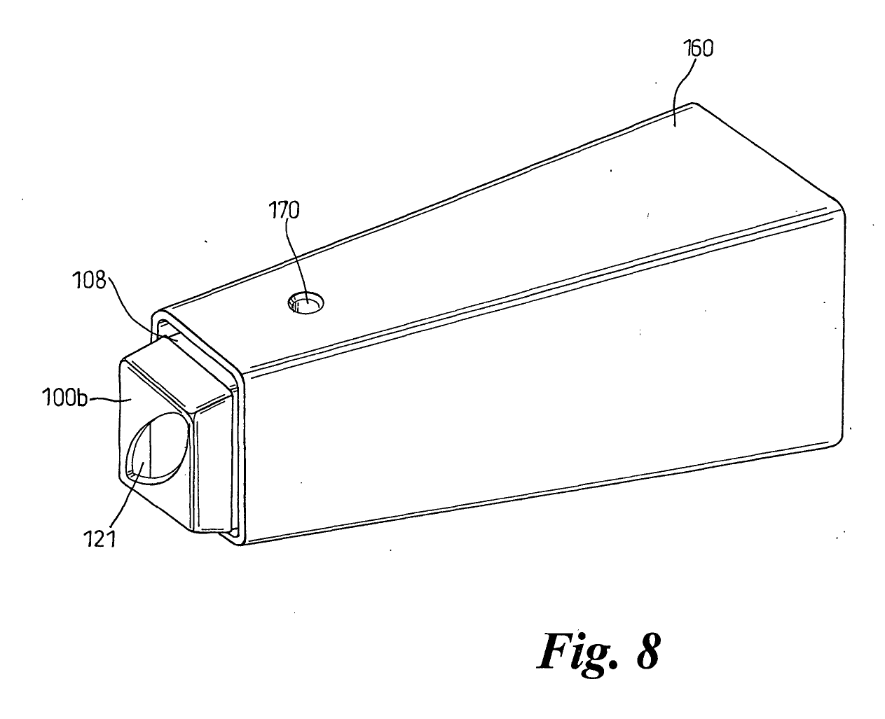

FIG. 8 shows a perspective view of the trap of FIG. 7, with a case fitted over it;

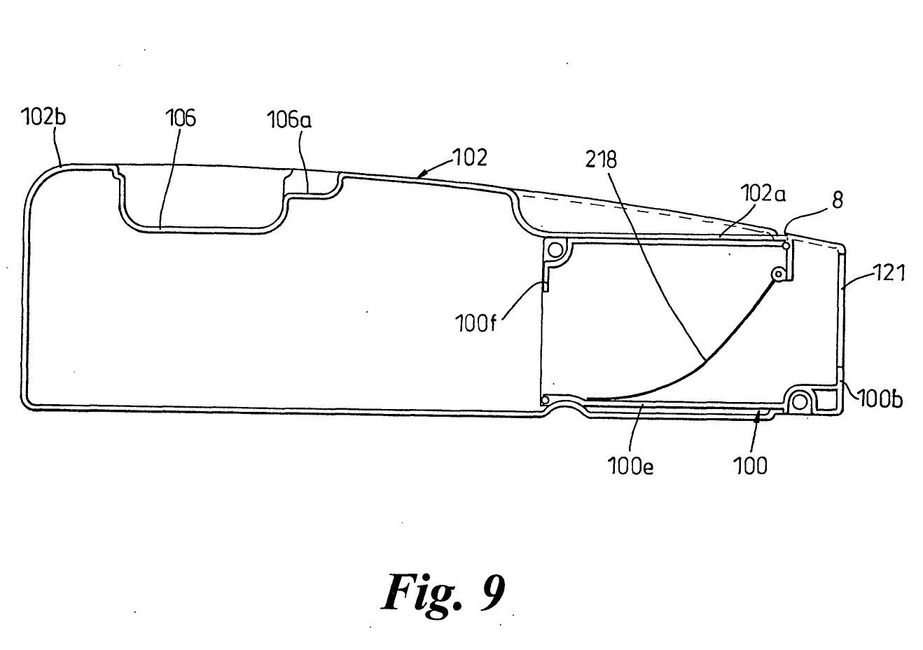

FIG. 9 shows, in longitudinal section, a second design of entry means; and

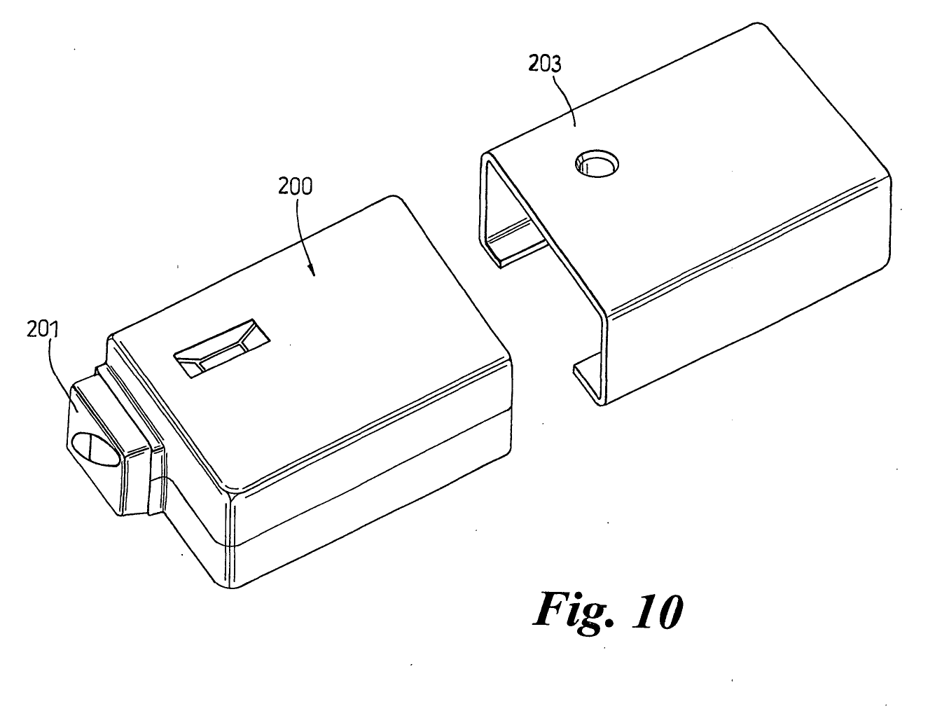

FIG. 10 shows an expanded view of a trap of a third embodiment the present invention.

FIG. 1 shows a first embodiment of a rodent trap of the present invention. The trap comprises a rodent entry means 1 and a catch compartment 2. The entry means 1 has an internal sealing means 3 associated with it.

The entry means 1 is die cast from a zinc alloy, the catch compartment 2 and internal sealing means 3 are made by injection moulding of polypropylene.

The catch compartment 2 is semi-circular in shape with a straight edge 5 and curved edge 7. Two apertures 4a, 4b are provided in neck portions 10a, 10b extending parallel to straight edge 5 each to receive an entry means 1 by push-fit engagement. The aperture 4b is not visible in FIG. 1 as it is sealed with an external seal 12. The straight edge 5 is provided to lie flat against a wall in use.

The catch compartment 2 comprises an upper part 2a and a lower part 2b. The upper 2a and lower 2b parts of the catch compartment are secured together in use along their respective curved edges 7a, 7b and straight edges 5a, 5b. The two parts are secured together by the female portion 6a of a clip on the upper part 2a of the catch compartment receiving the male portion 6b of a clip on the lower part 2b of the catch compartment. The seal created between the upper 2a and lower 2b parts of the catch compartment 2 is liquid tight, extends around the catch compartment in a generally horizontal plane and is positioned above the surface on which the catch compartment rests.

When the female 6a and male 6b clip portions are not engaged the catch compartment 2 can be divided into two parts to give a stacking arrangement allowing for easy carrying of a large number of catch compartments.

FIGS. 1 and 2 show the entry means 1, which is elongate with a square cross-section, a first aperture 8 is provided in the front face 1a for the rodent to pass through. A second aperture 9 is provided in the side face 1b to allow the rodent to pass from the entry means into the catch compartment 2.

The entry means 1 is also provided with a counter viewing aperture 14 and the counter mechanism is discussed in more detail in relation to FIG. 5.

The entry means 1 can be dismantled along the vertical, central longitudinal axis 30 to give two inter-connectable portions 31,32. The portions are connected by male and female engaging members shown in FIG. 3. The portions 31, 32 are further secured by a “C” shaped clip 150 made of sprung steel or a nylon known as Delrin 500 and received in a channel 151 extending around the inter-connecting portions 31, 32 perpendicular to the longitudinal axis.

The internal sealing means 3 is elongate with a square cross-section and is sized to push fit over the end 1c of entry means 1 opposite the front face 1a. The sealing means 3 is provided with locking lugs 11 in its top 3a and bottom 3b faces. The locking lugs 11 can be depressed by the action of pushing the entry means 1 into the neck portion 10a,10b through the aperture 4a,4b but prevent the sealing means 3 from exiting the neck 10 of the catch compartment 2. The face 3e of the internal sealing means 3 is a mesh construction.

The sealing means 3 is provided with alignment flanges 13 extending from side faces 3c,3d sized and shaped to pass snugly through the neck 10a,10b of the catch compartment 2.

Also provided is an external sealing means 12 that fits over the aperture 4a,4b in the neck 10a,10b in addition to the internal sealing means to ensure the catch compartment is completely sealed, preventing the escape of live or dead catch and biohazards.

FIG. 3 shows a perspective view of the entry means 1 shown in FIG. 2 when the portion 32 has been removed. Like numbers indicate like parts. The aperture 9 provided in the side face 1b of the entry means 1 for the rodent to exit the entry means 1 into the catch compartment 2 is visible.

Male connection members 33,34 are provided on portion 31 and correspond with female connection members (not shown) on portion 32 to secure the two portions 31 and 32 together. The channel 151 for receiving the “C” shaped clip 150 can be seen.

The entry means 1 is provided with a seesaw 15 made from steel by metal pressing. The see-saw 15 is substantially as wide as the entry means 1 and has a first end 15a positioned near the aperture 8 and a second end 15b positioned near the aperture 9. The seesaw 15 is pivotally attached to the base 1e of the entry means 1 about a pivot 16.

FIG. 3 shows the seesaw 15 in the first position, with the end 15a resting on the base 1e of the entry means 1 and the end 15b resting against a stop (not shown) positioned above the aperture 9. This arrangement means that exit through aperture 9 is blocked but entry through aperture 8 is possible.

A door member 17 is pivotally attached by depending extensions of its lower edge 17a to the base 1eof entry means 1, by a second pivot 18. Pivot 18 is positioned between the aperture 8 and pivot 16, such that the door member 17 and the end 15a of the seesaw 15 pivot, in opposing directions. The door member 17 is sized to cover, in use, the aperture 8.

In the first position the door member 17 lies flat against the seesaw 15 allowing entry of a rodent through the aperture 8.

The second position of the seesaw arrangement is shown in FIG. 4, where like numbers again indicate like parts. In the second position, the end 15b of the seesaw 15 rests on the base 1e of the entry means 1, opening the aperture 9.

The end 15a of the seesaw 15 is elevated by rotation about the pivot 16 in the clockwise direction, which causes rotation of the door member 17 in an anticlockwise direction until it contacts a stop 19 depending from the inner surface of top face 1c and closes the aperture 8. The end 15a of the seesaw 15 is provided with a weight 20 secured thereto.

In use, the rodent enters the entry means 1 through aperture 8 with the seesaw in the first position and steps onto door member 17, resting on end 15a of seesaw 15. The rodent progresses along the seesaw 15 towards end 15b causing the seesaw 15 to tilt until end 15b rests on the base of the entry means 1, thereby opening aperture 9. The tilting of the seesaw 15 also causes rotation of the door member 17 until it hits the stop 19 above aperture 8 and blocks aperture 8. The rodent can then only progress into the catch compartment 2 through the aperture 9. If the rodent tries to return towards the end 15a of the seesaw, the presence of the door member 17 will prevent it from being able to exit through aperture 8.

When the rodent has entered the catch compartment 2, the weight 20 on the end 15a of the seesaw 15 causes the seesaw to return to the first position and allows the door member 17 to pivot away from the aperture 8 for the next rodent to enter.

When it is time for the trap to be emptied each entry means 1 is removed from the corresponding aperture 4a, 4b of the catch compartment 2. As each entry means 1 is removed from the corresponding aperture 4a,4b of the catch compartment 2 the corresponding internal sealing means 3 passes into the neck portion 10a,10b of the catch compartment 2 but can go no further owing to the locking lugs 11 contacting the internal edge of the neck 10a,10b. The internal sealing means 3 lodges in the neck 10a, 10b and provides a first seal for the catch compartment preventing the escape of any live catch. The apertures 4a,4b of the catch compartment 2 are then sealed with the external sealing means 12 and the catch compartment and contained catch is disposed of appropriately.

A new catch compartment 2 is prepared by securing an upper 2a and lower 2b part of the catch compartment together by means of the male and female clip portions 6a, 6b. The entry means 1 associated with new internal sealing means 3 are push-fit into the necks 10a, 10b of the empty catch compartment 2 through apertures 4a, 4b and the trap is ready for use again without the need to first empty and clean the used catch compartment 2.

FIG. 5 shows the counter mechanism for use with the entry means 1 of FIGS. 1-4. The counter mechanism is positioned behind front face 1a of the entry means 1 above aperture 8. The counter mechanism includes a rotationally mounted counter wheel 21 having a series of increasing integers 22 beginning at zero displayed around its outer surface. One integer 22 is visible through the counter display aperture 14 at any one time. The counter wheel 21 is also provided with indentations 23 around its outer surface between integers 22. An elongate locking mechanism 24 is provided to engage a suitable indentation 23 to hold the desired integer 22 in position so that it is visible through the counter display aperture 14. The locking mechanism is pivotally mounted on the inner face of portion 31 of the entry means behind the counter display aperture. The counter wheel 21 is provided with a cog 25 fixedly mounted on one or both of its side faces. The cog 25 has a corresponding number and position of indentations to the counter wheel 21. A slidably mounted rod 26 is provided between indentations on the cog 25 and the door 17.

On entry of a rodent through the aperture 8 as described above the door 17 contacts stop 19 to close aperture 8 and in doing so also pushes the rod 26 against the cog 25 forcing the cog 25 to rotate until the stop mechanism 24 contacts the next indentation 23 on the counter wheel 21. Therefore the counter wheel 21 moves round by one integer 22 each time a rodent enters the catch compartment 2.

FIG. 6 shows a cross section of a flag mechanism that can be used in combination with the entry means 1 in place of, or in addition to the counter mechanism to indicate whether any rodents have entered the trap. The flag mechanism is mounted above the aperture 8 and comprises an elongate indicator portion 27. In a first position the elongate indicator 27 is concealed within the entry means 1 and in a second position is visible outside the entry means 1 through an aperture 37 in front face 1a. The elongate member 27 is mounted on a weighted portion 28 pivotally and slidably mounted inside the entry means 1.

In the first position the weighted portion 28 holds the elongate portion inside the entry means 1 until the door 17 contacts the weighted portion on entry of a rodent. Contact of the door 17 against the weighted portion 28 causes the weighted portion 28 to slide and pivot until the elongate portion 27 is visible from the outside of the entry means 1 through aperture 37.

FIG. 7 shows a second embodiment of a rodent trap of the present invention. The trap comprises a rodent entry means 100 and a catch compartment 102. The entry means 100 is die cast from aluminium and the catch compartment 102 is injection moulded from polyethylene. The catch compartment 102 has a rectangular neck portion 102a with an opening at one end and a hollow wedge shaped container portion 102b extending from the other end. The catch compartment 102 is shaped to lie flat against a wall in use.

The entry means 100 is rectangular in section, with an aperture 121 provided in the front face 100b for the rodent to pass through. The entry means 100 is provided with a recess 103 in its top surface 100c and the neck portion 102a is provided with a lug 104 on the corresponding inner surface 102c. The recess 103 and lug 104 may be provided on the bottom or the top, or both surfaces of the entry means and catch compartment. The entry means 100 is push-fitted into the neck portion 102a and held in place by engagement of the lug 104 in the corresponding recess 103. The entry means 100 is provided with a shoulder 108 extending around its outer surface to prevent the entry means from being pushed right into the catch compartment. The shoulder 108 engages a lip 107 on the neck 102a of the catch compartment.

Also provided as part of the trap is a closure means 105 for sealing the catch compartment 102. The closure means 105 is housed in a recess 106 provided in outer surface of the portion 102b of the catch compartment when not in use. The recess 106 is provided with a thumbhole 106a to aid removal of the closure means 105. The closure means 105 is also made by injection moulding polyethylene and is sized so as to push-fit over lip 107 in use.

FIG. 8 shows the trap of FIG. 7 assembled and contained in a die cast metal casing 160. The casing 160 has a lug 170 on its inner surface corresponding to the profile on the outer surface of the lug 104 provided on the catch compartment 102. It is necessary to remove the casing 160 before being able to remove the entry means 100 from the catch compartment 102.

FIG. 9 shows an alternative to the seesaw arrangement of FIGS. 3, 4, 7 or 8. The trap of FIGS. 7 and 8 is used as an example in FIG. 9.

The entry means is provided with a curved aluminium flap 218. The flap 218 is hung behind the aperture 121 from the inside upper surface of the entry means 100 and is curved so that it meets the base 10e of the entry means and extends along the base of the entry means 100.

In use, a rodent enters the entry means 1, 100 through the aperture 8, 121 and is able to pass under the curved flap 218 in the direction of the aperture 9. The rodent cannot however crawl back under the curved flap 218 towards aperture 8, 121 owing to the shape of the flap which has a large portion lying on the base 1e, 100e of the entry means 1.

FIG. 10 shows an alternative shaped trap to those shown in FIGS. 1-9. In the trap of FIG. 10, the catch compartment 200 is rectangular in section and the entry means 201 is received in a corner thereof. The trap works in the same way as described in relation to FIGS. 1-9. A casing 203 is provided to house the catch compartment 200 and entry means 201 assembly.

1. A rodent trap comprising one or more rodent entry means secured to a catch compartment for containing rodents once they have been caught, wherein the or each entry means allows a rodent to enter the catch compartment but prevents the rodent from exiting the catch compartment and the or each entry means is releasably secured to the catch compartment.

2. A trap according to claim 1 wherein the or each entry means comprises an enclosed corridor having a first aperture for a rodent to enter the entry means and a second aperture for the rodent to exit the entry means into the catch compartment.

3. A trap according to claim 2 wherein means are provided to prevent the rodent from leaving the or each entry means once it has passed through the first aperture and has begun travelling towards the second aperture.

4. A trap according to claim 3 wherein the means to prevent the rodent from leaving the entry means is a seesaw arrangement comprising a seesaw having a first position and a second position.

5. A trap according to claim 4 wherein in the first position a first end of the seesaw rests on the base of the entry means allowing a rodent to enter through the first aperture, while a second end of the seesaw is elevated and closes the second aperture and in the second position the second end of the seesaw rests on the base of the entry means and the first end of the seesaw is the elevated.

6. A trap according to claim 4 or claim 5 wherein the see-saw is weighted, so that once the rodent has stepped off the second end into the catch compartment the seesaw returns to the first position.

7. A trap according to claim 3 wherein the means to prevent the rodent from leaving the or each entry means comprises a curtain.

8. A trap according to claim 7 wherein the curtain is positioned behind the first aperture such that it can be easily pushed out of the way by a rodent entering the entry means through the first aperture, but the curtain cannot be pushed out of the way by a rodent trying to leave the entry means through the first aperture.

9. A trap according to claim 7 or claim 8 wherein the curtain is a curved metal flap.

10. A trap according to claim 7 or claim 8 wherein the curtain is made from a heavy rubber.

11. A trap according to any preceding claim wherein the or each entry means is provided with one or more means to indicate the presence of rodents in the trap.

12. A trap according to claim 11 wherein the means to indicate the presence of rodents in the trap is a flag mechanism.

13. A trap according to claim 12 wherein the flag is moved from a first position to a second position on entry of a rodent into the catch compartment through the entry means.

14. A trap according to claim 11 wherein the means to indicate the presence of rodents in the trap is a counter mechanism.

15. A trap according to any preceding claim wherein the entry means comprises two or more inter-connectable portions.

16. A trap according to claim 15 wherein the inter-connectable portions,are connected by means of male and female connecting parts.

17. A trap according to claim 15 or claim 16 wherein a “C” shaped clip is provided to secure the inter-connectable portions together.

18. A trap according to any preceding claim wherein the or each entry means is secured to the catch compartment by complementary screw threads provided on the catch compartment and the entry means, or by means of push-fit engagement or by male-female engaging clips.

19. A trap according to any preceding claim wherein the or each entry means is associated in use with an internal sealing member.

20. A trap according to claim 19 wherein the internal sealing member engages the inside edges of the aperture in the catch compartment that receives the entry means on removal of the entry means to at least partially seal the aperture once the entry means is removed.

21. A trap according to any preceding claim wherein the catch compartment is disposable.

22. A trap according to any preceding claim wherein the catch compartment comprises two separate parts.

23. A trap according to any one of claims 1 to 21 wherein the catch compartment comprises two parts connected by one or more hinges or by a common side, which in use co-operate to form a catch compartment.

24. A trap according to claim 22 or claim 23 wherein the two parts of the catch component are secured together in use in a generally horizontal plane.

25. A trap according to any one of claims 22 to 24 wherein the two parts are secured together by means of a liquid tight seal.

26. A trap according to claim 25 wherein the two parts are secured together in use to form the catch compartment by the use of male and female engaging clip portions.

27. A trap according to any preceding claim wherein the catch compartment includes a transparent portion to allow the catch to be inspected.

28. A trap according to any preceding claim wherein the catch compartment includes poison to kill the rodents or small holes to allow the rodents to be drowned or bait.

29. A trap according to any preceding claim wherein the trap is provided with a case to protect it from being tampered with.

30. A trap according to any preceding claim wherein the trap is provided with an external sealing means for sealing the catch compartment when it has been detached from the entry means.
